(19) United States
(12) Patent Application Publication
(10) Pub. No.: US 2005/0053864 A1
(43) Pub. Date: Mar. 10, 2005

(54) Phthalocyanine precursors in infrared sensitive compositions

(76) Inventor: Rolf Dessauer, Greenville, DE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/656,503

(22) Filed: Sep. 5, 2003

(51) Int. Cl. G11B 7/24; G03C 5/00

(52) U.S. Cl. 430/270.15; 430/270.14; 430/945; 430/338; 503/225

(57) ABSTRACT

Compositions and methods for production of color images using phthalocyanine precursor-containing color forming compositions are described. The color forming composition can include a phthalocyanine precursor, an infrared absorber, and a binder. The color forming composition can be optimized for development in less than 1 msec using infrared radiation. The phthalocyanine precursor can include a phthalocyanine and a leaving group, or groups, each coordinated to a metal. The color forming compositions are ambient light stable and are useful in forming images on a wide variety of substrates.

### FIELD OF THE INVENTION

The present invention relates generally to color forming compositions. More particularly, the present invention relates to phthalocyanine precursor compositions and their use in forming color images.

### BACKGROUND OF THE INVENTION

Compositions which produce a color change upon exposure to light or heat are of great interest in producing images on a variety of substrates. Optical disks represent a significant percentage of the market for data storage of software as well as of photographic, video, and/or audio data. Typically, optical disks have data patterns embedded thereon that can be read from and/or written to one side of the disk, and a graphic display printed on the other side of the disk.

In order to identify the contents of the optical disk, printed patterns or graphic display information can be provided on the non-data side of the disk. The patterns or graphic display can be both decorative and provide pertinent information about the data content of the disk. In the past, commercial labeling has been routinely accomplished using screen-printing methods. While this method can provide a wide variety of label content, it tends to be cost ineffective for production of less than about 400 disks because of the fixed costs associated with preparing a stencil or combination of stencils and printing the desired pattern or graphic display.

In recent years, the significant increase in the use of optical disks for data storage by consumers has increased the demand to provide customized labels to reflect the content of the optical disk. Most consumer available methods of labeling are limited to either handwritten descriptions or preprinted labels which may be affixed to the disk, but which can also adversely affect the disk performance upon spinning at high speeds.

In accordance with the present invention, a variety of leuco dye-containing compositions have been investigated for use on optical disks and other substrates. Typical leuco dye compositions include a leuco dye along with an activator. However, many of these compositions are insufficiently stable under ambient light conditions for practical use. For this and other reasons, the need still exists for leuco dye compositions which have improved stability, and which have improved image forming and developing characteristics.

### SUMMARY OF THE INVENTION

It has been recognized that it would be advantageous to develop rapidly developable and light stable color forming compositions.

In one aspect of the present invention, a color forming composition can include a dye precursor composition and an infrared absorber. The dye precursor composition can include a phthalocyanine precursor and a binder. The infrared absorber can be admixed with or in thermal contact with the dye precursor composition. The color forming compositions described herein can be optimized for development in less than about 1 msec using infrared radiation.

In another aspect of the present invention, a method of forming color images on a substrate can include applying the color forming composition onto a substrate. Infrared radiation can then be applied to the color forming composition sufficient to cause reduction of the phthalocyanine precursor to form a phthalocyanine dye without decomposing the color forming composition.

The above compositions and methods can be utilized via a system for labeling a substrate. The system can include an image data source, an optical disk substrate having the color forming composition coated thereon, and an infrared radiation source. The infrared radiation source can direct infrared radiation having a wavelength of from about 760 nm to less than 850 nm to the color forming composition.

Additional features and advantages of the invention will be apparent from the detailed description which follows, which illustrates, by way of example, features of the invention.

### DETAILED DESCRIPTION

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, which would occur to one skilled in the relevant art and having possession of this disclosure, are to be considered within the scope of the invention. Further, before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a suppression agent” includes reference to one or more of such materials.

As used herein, the term “color forming composition” typically includes a phthalocyanine precursor, a binder, and an infrared absorber. These components can work together upon exposure to infrared radiation to reduce the phthalocyanine precursor to the corresponding phthalocyanine dye. For purposes of the present invention, the term “color” can be any change in visible absorbance that occurs upon development, including development to black, white, or traditional colors. Similarly, the phthalocyanine precursor can be colorless or may have some color which changes upon development to a different color.

As used herein, “developing,” “development,” or the like refers to the interaction or reaction which reduces substantially all of the phthalocyanine precursor to produce a visible change in color through reduction to the corresponding phthalocyanine dye.

As used herein, “dye precursor composition” refers to a mixture which includes phthalocyanine precursor and binder. The dye precursor composition can be admixed with or in thermal contact with an infrared absorber to form the color forming compositions of the present invention.

As used herein, “infrared absorber” refers generally to an infrared radiation sensitive agent that can generate heat or otherwise transfer energy to surrounding molecules upon exposure to infrared radiation. Infrared radiation includes near infrared radiation in the range of from about 700 nm to about 40 μm, although about 700 nm to about 1200 nm is common for most near infrared applications. When admixed with or in thermal contact with a phthalocyanine precursor, an absorber can be present in sufficient quantity so as to produce heat sufficient to at least partially develop the phthalocyanine precursor in accordance with embodiments of the present invention.

As used herein, “leaving group” refers to at least one chemical group which is attached to a metal by coordination bonds. Typically, the metal can be also bonded to a phthalocyanine group. The leaving group can include a single group having at least two moieties capable of coordination bonding with the metal. Alternatively, the leaving group can include two separate groups such as methoxy, amino, diiminoisoindolino, hydroxy, chloro, ethylenediamino, and the like.

The term “thermal contact” refers to the spatial relationship between an absorber and a color forming composition. For example, when an absorber is heated by interaction with infrared radiation, the heat generated by the absorber should be sufficient to cause the phthalocyanine precursor of the color forming composition to darken through a reduction reaction. Thermal contact can include close proximity between an absorber and a color forming composition, which allows for heat transfer from the absorber toward the phthalocyanine precursor. Thermal contact can also include actual contact between an absorber and phthalocyanine precursor, such as in immediately adjacent layers, or in an admixture including both constituents.

As used herein, “stabilizing agent” refers to compositions that can be used to reduce undesired development of phthalocyanine precursors upon exposure to ambient or other light sources.

The term “spin-coatable composition” includes a liquid carrier having various components dissolved or dispersed therein. In some embodiments, the spin-coatable composition can comprise a color forming composition and an infrared absorber in a common liquid carrier. In other embodiments, fewer components can be present in a liquid carrier forming the spin-coatable composition. Thus, for example, the color forming composition can be spin-coatable and applied to a substrate and then an infrared absorber can be formed in a separate layer which can be applied by spraying, screen-printing, or other methods which do not require spin-coatability. Color forming compositions can be spin-coatable in one embodiment, or can be configured for other application methods as well, e.g., printing such as offset, inkjet, gravure, roller coating or other application methods known to those skilled in the art.

As used herein, “optimization” and “optimized” refer to a process of selection of components of the color forming composition which results in a rapidly developable composition under a fixed period of exposure to infrared radiation. For example, typically, compositions of the present invention can be optimized for development using 780 nm laser light in which substantially all of the color forming composition exposed to the infrared radiation is developed in less than a predetermined period of time, e.g., 1 msec. Each component of the color forming composition can potentially influence the developing properties of the composition. For example, certain binders can either accelerate or hinder the developing times of various combinations of phthalocyanine precursor and infrared absorber. However, “optimized” does not necessarily indicate that the color forming composition is developed most rapidly at a specific wavelength, but rather that the composition can be developed within a specified time frame using a given infrared radiation source. An optimized composition would also indicate an ambient light stability over extended periods of time, i.e. several months to years.

As used herein, “optical disk” is meant to encompass audio, video, multi-media, and/or software disks that are machine readable in a CD and/or DVD drive, or the like. Examples of optical disk formats include writeable, recordable, and rewriteable disks such as DVD, DVD-R, DVD-RW, DVD+R, DVD+RW, DVD-RAM, CD, CD-ROM, CD-R, CD-RW, and the like. Other like formats may also be included, such as similar formats and formats to be developed in the future.

As used herein, “graphic display” can include any visible character or image found on an optical disk. Typically, the graphic display is found prominently on one side of the optical disk, though this is not always the case.

As used herein, “data” is typically used with respect to the present disclosure to include the non-graphic information contained on the optical disk that is digitally or otherwise embedded therein. Data can include audio information, video information, photographic information, software information, and the like.

It is important to note that, with respect to phthalocyanine precursors, absorbers, reducing agents, stabilizing agents, and other non-liquid carrier components, the weight percent values are measured relative to a dry basis, thus excluding the liquid carrier. In other words, unless otherwise specified, values of “wt %,” “% by weight,” or “weight percent” refer to the compositions that will be present in the color forming composition excluding any carrier, such as after drying or curing, as in case of UV (ultraviolet) or EB (electron beam) curable formulations, on a substrate.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 μm to about 200 μm should be interpreted to include not only the explicitly recited limits of 1 μm to about 200 μm, but also to include individual sizes such as 2 μm, 3 μm, 4 μm, and sub-ranges such as 10 μm to 50 μm, 20 μm to 100 μm, etc.

In accordance with the present invention, the color forming composition can include a dye precursor composition and an infrared absorber admixed with or in thermal contact with the dye precursor composition. The dye precursor composition can include a phthalocyanine precursor and a binder. In one aspect, the color forming composition can be optimized for development in less than about 1 msec without subsequent processing. One additional embodiment of the present invention includes a color forming composition having a dye precursor composition and an infrared absorber admixed with or in thermal contact therewith. The dye precursor composition can include a phthalocyanine precursor and a binder such that the phthalocyanine precursor has a phthalocyanine and a leaving group(s) each coordinated to a metal.

Upon application of infrared energy, the infrared absorber and dye precursor composition are heated sufficiently to cause reduction of the phthalocyanine precursor to form the phthalocyanine dye or pigment. The specific phthalocyanine precursor, infrared absorber, and binder each affect the stability and development properties of the color forming composition and are discussed in more detail below.

Dye Precursor Composition

In one aspect of the present invention, the color forming composition includes a dye precursor composition. The dye precursor composition can include at least a phthalocyanine precursor and a binder. In one embodiment, the phthalocyanine precursor can include a phthalocyanine and a leaving group, both coordinated to a metal. Metal phthalocyanine pigments and dyes are insoluble in most solvents and often exhibit intense colors such as blue and copper which are highly stable. However, phthalocyanine precursors suitable for use in the present invention are soluble in many standard solvents and can include a leaving group. Suitable leaving groups include, without limitation, methoxy, amino, diiminoisoindolino, hydroxy, chloro, ethylenediamino, and mixtures thereof. Upon addition of heat and/or reaction with a suitable reducing agent, the leaving groups are removed, leaving the phthalocyanine dye bonded to the metal. Typically, the addition of heat is sufficient to cause reduction of the phthalocyanine precursor without the use of an additional reducing agent. A thorough review of several suitable phthalocyanine precursors and associated methods of preparing these compounds can be found in K. Venkataraman, ed., The Chemistry of Synthetic Dyes, vol. V, New York: Academic Press, 1971, Chapter V: Phthalogen Dyestuffs, pp. 283-311, which is hereby incorporated by reference. Typical starting materials for producing phthalocyanines and their precursors can include 1,3-diiminoisoindoline, substituted 1,3-diiminoisoindolines such as 5-phenyl-diiminoisoindoline, 5-methoxy-diiminoisoindoline, and 4-azadiiminoisoindoline, although other methods of synthesis are known. In one aspect, the phthalocyanine precursor can be formed from 1,3-diiminoisoindoline, as shown in Formula I below: 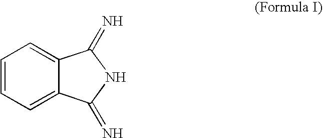
The phthalocyanine precursors of the present invention can include a metal having at least one of its coordination numbers greater than four such as Cu, Co, Ni, Zn, Cr, Fe, Mn, Mg, Ca, Ti, V, etc. The high coordination number is typical, because the phthalocyanine portion of the precursor can coordinate with four sites of the metal, and in this configuration, the metal has additional coordination sites to accommodate one or more leaving groups. The metal can also include two metals having a single valency with a coordination number greater than four. In one embodiment, the metal can be copper (II). The metal can influence the color of the phthalocyanine precursor and the corresponding phthalocyanine dye. The precursor can be colorless or have a color which is different than the corresponding dye. For example, the precursor known commercially as LUSANE Brilliant Blue B (having copper (II) as the metal) has a yellowish-brown color, and upon development, has a dark blue appearance. Similarly, precursors containing complexed cobalt can be yellow, orange-yellow, or brown-yellow, while complexed nickel precursors can be a light brownish-red. The developed phthalocyanine dyes are typically intense blue, green (e.g., phenyl-diiminoisoindoline based dyes), or turquoise, although dyes produced from 4-azadiiminoisoindoline typically exhibit redder shades than other phthalocyanine dyes.

Suitable phthalocyanine precursors can include, for example, the LUSANE dyes such as Brilliant Blue B, Blue I IB, (available from E. I Du Pont de Nemours and Co., Inc., of Wilmington, Del.) and Phthalogen Brilliant Blue IF3GK, Phthalogen Brilliant Blue IF3G, Phthalogen Turquoise IFBK, Phthalogen Brilliant Green IF2B, Phthalogen Brilliant Green IFFB, and Phthalogen Blue JB (available from Farbenfabriken Bayer A. G., Leverkusen, Germany and Sitaram Chemicals, Thane, Maharashtra State, India). Other suitable phthalocyanine (Pc) precursors include amido-diiminoisoindolino-Pc-cobalt complex, chloro-diiminoisoindolino-Pc-cobalt complex, hydroxy-diiminoisoindolino-Pc-cobalt complex, ethylenediamino-diiminoisoindolino-Pc-cobalt complex (Phthalogen Blue JB), methoxy-diiminoisoindolino-Pc-copper complex (Phthalogen Brilliant Blue IF3GK), dimethoxy-Pc-copper complex, dimethoxy-Pc-nickel complex (Turquoise IFBK), and the like. In one aspect, the phthalocyanine precursor can be LUSANE Brilliant Blue B having the structure shown as Formula II below: 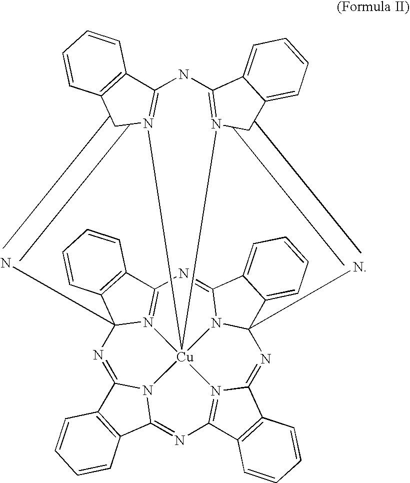
U.S. Pat. Nos. 2,772,284; 2,795,586; 2,957,004; and Brooks et al, J. Org. Chem., vol. 24, p.3 (1959), each hereby incorporated by reference, describe several suitable methods of producing LUSANE-type precursors, although other methods known to those skilled in the art can be used. In another aspect, the phthalocyanine precursor can be Phthalogen Brilliant Blue IF3GK having the structure of Formula III below: 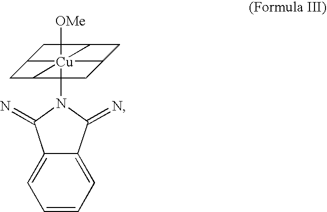
where the box around the copper is used to represent a phthalocyanine ring for clarity. Other suitable Phthalogen precursors can include phthalocyanine rings having various groups substituted at a carbon of the phthalocyanine ring. For example, chloride, hydroxy, and methoxy groups can be added to the phthalocyanine ring by treatment with benzoyl peroxide in an alkaline solution. Such a process is described in detail in C. J. Pedersen, “Reversible Oxidation of Phthalocyanine,” J. Org. Chem., vol. 22, pp. 127-132 (1956).

In one alternative embodiment, the phthalocyanine precursor can comprise a 1,3-diiminoisoindoline and a metal donor. The diiminoisoindoline and the metal donor can then be applied to a substrate along with an infrared absorber to form the color forming composition. Upon development, the diiminoisoindoline and metal donor can react to form the phthalocyanine ring to produce a dye. Suitable 1,3-diiminoisoindolines can include 1,3-diiminoisoindoline, 5-phenyl-1,3-diiminoisoindoline, 5-methoxy-1,3-diiminoisoindoline, and 4-aza-1,3-diiminoisoindoline. Suitable metal donors can include metal complexes of hydroxyethyl sarcosine having the following general structure 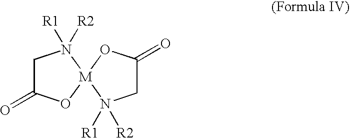
where R1 and R2 can be methyl, β-hydroxyethyl, or carboxymethyl and M can be copper or nickel. Two commercial products are available under the tradenames Phthalogen K (where M is Cu, R1 is methyl, and R2 is β-hydroxyethyl) and Phthalogen Ni (where M is Ni, R1 is methyl, and R2 is β-hydroxyethyl). Commercial products including a mixture of a diiminoisoindoline and metal donor are known by the tradenames Phthalogen Brilliant Blue IF3GM (diiminoisoindoline and Phthalogen K), Phthalogen Turquoise IFBM (diiminoisoindoline and Phthalogen Ni), Phthalogen Brilliant Green IFFBM (5-phenyl-diiminoisoindoline and Phthalogen K), and Phthalogen Brilliant Green IF2BM (5-methoxy-diiminoisoindoline and Phthalogen K). The developer 1,3-diimino-4,7-dithia-4,5,6,7-tetrahydroisoindolene can be added to the above mixtures of diiminoisoindoline and metal donor to provide an increased red color to the developed dyes. Those skilled in the art will recognize the methods of synthesizing such compounds and exemplary methods are described in the aforementioned publication edited by Venkataraman.

Typically, the phthalocyanine precursor can be present in color forming compositions of the present invention at from about 1 wt % to about 40 wt %. Although amounts outside this range can be successfully used, depending on the other components of the composition, amounts of from about 5 wt % to about 20 wt % frequently provide adequate results.

The dye precursor composition can include a binder. Various binders can influence the development properties of the color forming composition such as development speed, light stability, and wavelengths which can be used to develop the composition. Suitable binders can include, but are not limited to, polymeric materials such as polyacrylate from monomers and oligomers, polyvinyl alcohols, polyvinyl pyrrolidines, polyethylenes, polyphenols or polyphenolic esters, polyurethanes, acrylic polymers, and mixtures thereof. For example, the following binders can be used in the dye precursor composition of the present invention: cellulose acetate butyrate, ethyl acetate butyrate, polymethyl methacrylate, polyvinyl butyral, and mixtures thereof. Ethyl acetate butyrate has shown particularly good results in connection with the LUSANE dyes discussed above. Although the binder can remain on a substrate after development, the binder does not necessarily have to remain on the substrate, and may be evaporated or otherwise removed from the substrate.

Depending on the specific phthalocyanine precursor, the color forming composition can optionally include a reducing agent. Typical reducing agents include ascorbic acid, 1-phenyl-3-pyrozolidone (phenidone), hydrazine, formamide, formic acid, phenols and substituted phenols, e.g., hydroquinone, and mixtures thereof. In order to provide desirable color forming properties and spin-coatability, various factors such as viscosity and solids content can be considered. The color forming compositions of the present invention can have less than about 10 wt % of solids, which typically provides good coating properties. For example, in one aspect, the solids content of a spin-coatable color forming composition can be from about 5 wt % to about 9 wt %, and in one embodiment, the solids content can be about 7 wt %. Further, it is sometimes desirable to add a plasticizer to improve coating flexibility, durability, and coating performance. Plasticizers can be either solid or liquid plasticizers. Such suitable plasticizers are well known to those skilled in the art, as exemplified in U.S. Pat. No. 3,658,543, which is incorporated herein by reference in its entirety.

Infrared Radiation Absorber

An infrared radiation absorber can be included in the color forming composition as a component which can be used to optimize development of the color forming composition at a predetermined speed and/or wavelength. The infrared absorber can be applied as a separate layer which can be optionally spin-coatable or printable, or can be applied in a common liquid carrier with the dye precursor composition. The infrared absorber can act as an energy antenna, providing heat to surrounding areas upon interaction with an energy source. As a predetermined amount of heat can be provided by the infrared absorber, matching of the infrared wavelength and intensity to the particular absorber used can be carried out to optimize the system. The infrared absorber can be present in the color forming composition in an amount of from about 0.001 wt % to about 10 wt %, and typically, from about 0.5 wt % to about 1 wt %, although other weight ranges may be desirable depending on the activity of the particular absorber. These weight percentages represent an amount of infrared absorber that can be present when mixed with the dye precursor. These weight percentages can be altered in other embodiments, such as when the infrared absorber is applied in a separate layer of the color forming composition. Thus, it will be understood that although the color forming composition typically includes at least a phthalocyanine precursor, binder, and infrared absorber as a single phase mixture, the absorber can alternatively be included in a separate layer from the phthalocyanine precursor and binder.

Various absorbers will act as an antenna to absorb electromagnetic radiation of specific wavelengths and ranges. Of particular interest is laser light having infrared wavelengths from about 600 nm to about 1200 nm. Therefore, the present invention can provide color forming compositions optimized for use in devices that emit wavelengths within this range. Typical commercial IR lasers found in common CD and DVD equipment are at a wavelength of about 650 nm, 780 nm, and 900 nm, while other commercial imaging lasers such as GaAs lasers can operate at 830 nm. Thus, the compositions of the present invention using appropriate infrared radiation absorbers can be used in equipment that is already commonly available on the market. In one embodiment, infrared wavelengths in the near infrared range having wavelengths from about 760 nm to about 1200 nm can be used in accordance with the present invention and in one aspect can be from about 760 nm to about 850 nm. In another more specific aspect, infrared radiation having a wavelength of from about 760 nm to about 800 nm can be used.

The absorber can be configured to be in a heat-conductive relationship with the dye precursor compositions of the present invention. For example, the infrared absorber can be placed in the same layer as the dye precursor composition as part of an admixture, or can be in a separate layer. Thus, the infrared absorber can be admixed with or in thermal contact with the dye precursor composition. In one aspect of the present invention, the infrared absorber can be applied to the substrate in a separate adjacent layer prior to or after applying the dye precursor composition as a layer to form a color forming composition on the substrate. In one embodiment, consideration can also be given to choosing the absorber such that any light absorbed in the visible range does not adversely affect the graphic display or appearance of undeveloped phthalocyanine precursor.

Although an inorganic compound can be used, e.g., ferric oxide, carbon black, selenium, and the like, the absorber typically can be an organic compound, such as, but not limited to polymethine dyes, polymethyl indolium dyes, metal complex IR dyes, cyanine dyes, indocyanine green, squarylium dyes, chalcogenopyryloarylidene dyes, croconium dyes, metal thiolate dyes, bis(chalcogenopyrylo)polymethine dyes, oxyindolizine dyes, bis(aminoaryl)polymethine dyes, merocyanine dyes, indolizine dyes, pyrylium dyes, quinoid dyes, heterocyclic compounds, and combinations thereof. Suitable polymethyl indolium compounds available from Aldrich Chemical Company include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof. In one aspect of the present invention, the IR absorber can be 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate. Other suitable absorbers can also be used in the present invention as are known to those skilled in the art and can be found in such references as Matsuoka, Masaru, ed., Infrared Absorbing Dyes, New York: Plenum Press, 1990 (ISBN 0-306434784) and Daehne, Resch-Genger, Wolfbeis, Near-Infrared Dyes for High Technology Applications, Kluwer Academic Publishers (ISBN 0-7923-5101-0), both of which are incorporated herein by reference in their entireties. Although, the specific activators and absorbers discussed herein are separate compounds, such activity can also be provided by constituent groups of a binder and/or phthalocyanine precursor which incorporates the activation and/or radiation absorbing action within the dye precursor composition.

Other Optional Ingredients

The color forming compositions of the present invention can also include various additional components such as stabilizing agents, colorants, liquid vehicles, and other additives known to those skilled in the art. Stabilizing agents can optionally be included in the color forming compositions of the present invention or in an adjacent layer. These stabilizing agents typically act to absorb visible and/or UV light in order to improve the light stability of the color forming composition. This helps to avoid unwanted development or degradation of the phthalocyanine precursor. Several examples of suitable stabilizing agents include a polyhydroxybenzophenone and derivatives thereof, hydroxylamine, triarylimidazole, hydroxyphenylbenzotriazole, and mixtures thereof.

Further, various additional components, such as lubricants, surfactants, and materials imparting moisture resistance, can also be added to provide mechanical protection to the color forming composition. Other overcoat compositions can also be used and are well known to those skilled in the art.

Infrared Radiation Application for Development

In one embodiment of the present invention, the color forming composition can be applied to a substrate. The composition can be applied using any known technique such as spin-coating, screen printing, sputtering, spray coating, ink-jetting, or the like. A variety of substrates can be used such as optical disks, polymeric surfaces, glass, ceramic, or cellulose papers. In one embodiment, the color forming composition can be applied to an optical disk and select portions thereof developed using a laser or heat source. Typically, an image to be formed on the surface can be digitally stored and then rasterized or spiralized. The resulting data can be delivered to an infrared radiation source which exposes portions of the color forming composition to infrared radiation while the optical disk is spinning. The infrared radiation source can be a laser such as those found in commercially available CD/DVD writeable and/or rewriteable systems.

The present invention relates generally to forming color images on a substrate using the color forming compositions of the present invention which can optionally be spin-coatable or printable. The compositions of the present invention can be prepared and applied in a variety of ways to a variety of substrates. For example, a color forming composition can be prepared that includes a liquid carrier, which can be substantially removed upon drying, that contains, without limitation, a phthalocyanine precursor, a binder, and an infrared absorber. The color forming composition can include a liquid carrier, which can act to improve coating performance, but which can be removed upon coating through known liquid removal processes. Typically, at least a portion of the liquid carrier can be driven off or allowed to evaporate after the coating process is complete. The liquid carrier can include, but is not limited to, solvents such as methylethyl ketone, isopropyl alcohol or other alcohols and diols, water, surfactants, and mixtures thereof.

The color forming composition can cover the entire surface of a substrate or merely a portion thereof. In one embodiment, in order for the color forming composition to be developed as desired on the optical disk surface, an infrared absorber layer can be formed on at least approximately the same portions of the optical disk as the dye precursor composition layer. This provides an optical disk having the absorber layer in thermal contact with the dye precursor composition layer. If the two layers are not in actual contact, but are close enough in proximity for thermal activation of the phthalocyanine precursor to occur, the layers can also be said to be in thermal contact. Alternatively, as stated, the infrared absorber can be admixed with the dye precursor composition to form the color forming composition.

Once the color forming composition is applied to the substrate, the conditions under which the color forming compositions of the present invention are developed can be varied. For example, one can vary the infrared radiation wavelength, heat flux, and exposure time. The amount of heat which is to be applied depends partially on the activation energy of the reduction reaction described above. However, the heat applied can be sufficient to remove the leaving group without also decomposing the color forming composition. Such an energy level is typically well below the energy required for decomposition of the color forming composition. Variables such as spot size, focus, and laser power will also affect any particular system design and can be chosen based on the desired results. With these variables, the infrared radiation source can direct infrared radiation to the color forming composition in accordance with data received from a signal processor. Further, phthalocyanine precursor and/or infrared radiation absorber concentration and proximity to one another can also be varied. Typically, the infrared absorber and the phthalocyanine precursor are present in a common layer, and thus, concentration ratios can be considered for a desired affect. However, if the color forming composition and infrared absorber are placed in separate layers, proximity can be considered.

The phthalocyanine precursors of the color forming compositions can be developed using lasers having from about 15 to 100 mW power usage, although lasers having a power outside this range can also be used. Typically, lasers having from about 30 mW to about 50 mW are readily commercially available. The spot size can be determined by the infrared radiation that contacts the substrate at a single point in time. The spot size can be circular or oblong in shape and can range from about 1 to about 200 μm along a largest dimension, though smaller or larger sizes can also be used. In one embodiment, a radiation spot size of from about 10 to about 60 μm can be utilized.

Heat flux is a variable that can be altered as well, and can be from about 0.05 to 5.0 J/cm² in one embodiment, and from about 0.3 to 0.5 J/cm² in a second embodiment. The color forming compositions of the present invention can be optimized by adjusting the concentrations and type of infrared absorber, phthalocyanine precursor, and binder. Heat flux in these ranges allow for development of phthalocyanine precursors in optimized compositions in from about 10 to about 100 microseconds per dot in some embodiments. Further, the color forming compositions of the present invention can be optimized for development in less than about 1 msec, such as from about 100 psec to about 500 psec. Similarly, the color forming compositions can be optimized for development using infrared radiation having wavelengths of from about 760 nm to about 1250 nm, such as from about 760 nm to about 850 nm. In one embodiment, optimization for an infrared wavelength of about 780 nm can be done to utilize the present invention in commercially available lasers. Those skilled in the art can adjust these variables and those discussed immediately above to achieve a variety of resolutions and developing times.

The following example illustrates an exemplary embodiment of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following Example provides further detail in connection with what is presently deemed to be one practical embodiment of the invention.

### EXAMPLE

A solution of 4.57 g of cellulose acetate butyrate (381-0.5) and 40 g of butanone-2 was formed. The phthalocyanine precursor, LUSANE Brilliant Blue IF3GK, in an amount of 1.100 g was added to the solution along with 400 mg of infrared absorber, IR-797 chloride. The solution was stirred overnight to form the color forming composition. The color forming composition was then coated on paper, polyethylene film, and several CDs. The coating on each substrate had a greenish color. Each coating was then exposed to infrared radiation at 780 nm for about 300 μsec. The exposed areas had a deep blue color, while the unexposed areas retained the light-green color resulting from the absorption of the infrared absorber.

It is to be understood that the above-referenced arrangements are illustrative of the application for the principles of the present invention. Numerous modifications and alternative arrangements can be devised without departing from the spirit and scope of the present invention while the present invention has been described above in connection with the exemplary embodiments(s) of the invention. It will be apparent to those of ordinary skill in the art that numerous modifications can be made without departing from the principles and concepts of the invention as set forth in the claims.

1. A color forming composition, comprising:
a) a dye precursor composition including a phthalocyanine precursor and a binder; and
b) an infrared absorber admixed with or in thermal contact with the dye precursor composition,
said color forming composition being configured for development in less than about 1 msec.

2. The composition of claim 1, wherein the phthalocyanine precursor includes a phthalocyanine and a leaving group both coordinated to a metal.

3. The composition of claim 2, wherein the phthalocyanine precursor includes the following structure

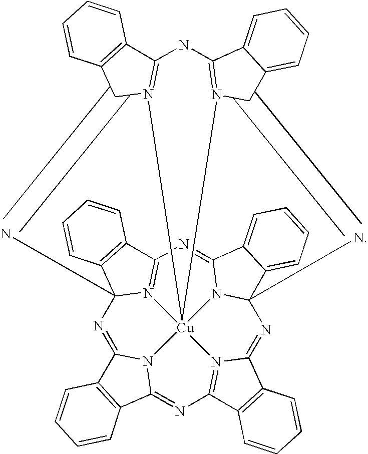

4. The composition of claim 1, wherein the phthalocyanine precursor comprises a 1,3-diiminoisoindoline and a metal donor.

5. The composition of claim 4, wherein said 1,3-diiminoisoindoline is a member selected from the group consisting of 1,3-diiminoisoindoline, 5-phenyl-1,3-diiminoisoindoline, 5-methoxy-1,3-diiminoisoindoline, and 4-aza-1,3-diiminoisoindoline and said metal donor is a metal complex of hydroxyethyl sarcosine.

6. The composition of claim 1, wherein the infrared absorber is selected from the group consisting of polymethine dyes, polymethyl indolium dyes, metal complex IR dyes, cyanine dyes, indocyanine green, squarylium dyes, chalcogenopyryloarylidene dyes, croconium dyes, metal thiolate dyes, bis(chalcogenopyrylo)polymethine dyes, oxyindolizine dyes, bis(aminoaryl)polymethine dyes, merocyanine dyes, indolizine dyes, pyrylium dyes, quinoid dyes, and mixtures thereof.

7. The composition of claim 6, wherein the infrared absorber is a polymethyl indolium dye, said polymethyl indolium dye being 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate.

8. The composition of claim 1, wherein the color forming composition is optimized for development using infrared radiation having a wavelength of from about 760 nm to less than 850 nm.

9. The composition of claim 1, wherein color forming composition is optimized for development in from about 100 psec to about 500 psec.

10. The composition of claim 1, wherein the binder is selected from the group consisting of cellulose acetate butyrate, ethyl acetate butyrate, polymethyl methacrylate, polyvinyl butyral, and mixtures thereof.

11. The composition of claim 10, wherein the binder is ethyl acetate butyrate.

12. The composition of claim 1, further comprising a reducing agent admixed with the dye precursor.

13. The composition of claim 12, wherein the reducing agent is a member selected from the group consisting of hydroquinone, phenidone, ascorbic acid, hydrazine, formamide, formic acid, and mixtures thereof.

14. The composition of claim 13, wherein the reducing agent is hydroquinone.

15. The composition of claim 1, wherein the color forming composition is spin-coatable.

16. A color forming composition, comprising:
a) a dye precursor composition including a phthalocyanine precursor and a binder, said phthalocyanine precursor including a phthalocyanine and a leaving group both coordinated to a metal; and
b) an infrared absorber admixed with or in thermal contact with the dye precursor composition.

17. An optical disk, comprising an optical disk substrate having a color forming composition coated thereon, said color forming composition including:
a) a dye precursor composition including a phthalocyanine precursor and a binder; and
b) an infrared absorber admixed with or in thermal contact with the dye precursor composition.

18. The optical disk of claim 17, wherein the phthalocyanine precursor includes a phthalocyanine and a leaving group both coordinated to a metal.

19. The optical disk of claim 18, wherein the phthalocyanine precursor includes the following structure

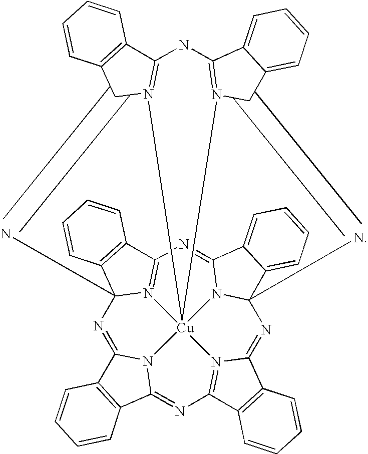

20. The optical disk of claim 17, wherein the infrared absorber is selected from the group consisting of polymethine dyes, polymethyl indolium dyes, metal complex IR dyes, cyanine dyes, indocyanine green, squarylium dyes, chalcogenopyryloarylidene dyes, croconium dyes, metal thiolate dyes, bis(chalcogenopyrylo)polymethine dyes, oxyindolizine dyes, bis(aminoaryl)polymethine dyes, merocyanine dyes, indolizine dyes, pyrylium dyes, quinoid dyes, and mixtures thereof.

21. The optical disk of claim 20, wherein the infrared absorber is 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate.

22. The optical disk of claim 17, wherein the infrared radiation absorber is in thermal contact with the phthalocyanine precursor.

23. The optical disk of claim 17, wherein said binder is an ethyl acetate butyrate.

24. The optical disk of claim 17, wherein said color forming composition is optimized for development using infrared radiation having a wavelength of from about 760 nm to about 800 nm.

25. The optical disk of claim 17, further comprising a stabilizing agent admixed with or layered over the color forming composition.

26. A method of forming color images on a substrate, comprising:
a) applying a color forming composition onto a substrate, said color forming composition being a mixture including:
i) a dye precursor composition including a phthalocyanine precursor and a binder; and
ii) an infrared absorber admixed with or in thermal contact with the dye precursor composition,
said color forming composition being configured for development in less than 1 msec; and
b) applying infrared radiation to the color forming composition sufficient to cause reduction of the phthalocyanine precursor to form a phthalocyanine dye without decomposing the color forming composition.

27. The method of claim 26, wherein the energy is applied at from about 0.3 to about 0.5 J/cm².

28. The method of claim 26, wherein the energy is applied for about 100 to about 500 microseconds.

29. The method of claim 26, wherein the energy is applied using an infrared laser having a wavelength of about 780 nm.

30. The method of claim 26, wherein the phthalocyanine precursor includes a phthalocyanine and a leaving group both coordinated to a metal.

31. The method of claim 26, wherein the infrared absorber is a member selected from the group consisting of polymethine dyes, polymethyl indolium dyes, metal complex IR dyes, cyanine dyes, indocyanine green, squarylium dyes, chalcogenopyryloarylidene dyes, croconium dyes, metal thiolate dyes, bis(chalcogenopyrylo)polymethine dyes, oxyindolizine dyes, bis(aminoaryl)polymethine dyes, merocyanine dyes, indolizine dyes, pyrylium dyes, quinoid dyes, and mixtures thereof.

32. The method of claim 26, wherein the substrate is an optical disk.

33. A system for labeling a substrate, comprising:
a) an image data source;
b) an optical disk substrate having a color forming composition coated thereon, said color forming composition comprising:
i) a dye precursor composition including a phthalocyanine precursor and a binder; and
ii) an infrared absorber admixed with or in thermal contact with the dye precursor composition; and
c) an infrared radiation source operatively connected to the image data source and configured to direct infrared radiation having a wavelength of from about 760 nm to less than 800 nm to the color forming composition.

34. The system of claim 33, wherein the phthalocyanine precursor includes a phthalocyanine and a leaving group both coordinated to a metal.

35. The system of claim 33, wherein the infrared absorber is a member selected from the group consisting of polymethine dyes, polymethyl indolium dyes, metal complex IR dyes, cyanine dyes, indocyanine green, squarylium dyes, chalcogenopyryloarylidene dyes, croconium dyes, metal thiolate dyes, bis(chalcogenopyrylo)polymethine dyes, oxyindolizine dyes, bis(aminoaryl)polymethine dyes, merocyanine dyes, indolizine dyes, pyrylium dyes, quinoid dyes, and mixtures thereof.

36. The system of claim 33, wherein the infrared radiation source produces radiation having a spot size from about 10 to about 60 μm.

37. The system of claim 33, wherein the infrared radiation source produces radiation at a power level from about 30 mW and about 50 mW.

38. The system of claim 33, wherein the substrate is an optical disk.
